(19) United States
(12) Patent Application Publication
(10) Pub. No.: US 2017/0188264 A1
(43) Pub. Date: Jun. 29, 2017

(54) ANALOG INTERFERENCE CANCELLATION USING DIGITAL COMPUTATION OF CANCELLATION COEFFICIENTS

(71) Applicant: QUALCOMM Incorporated, San Diego, CA (US)

(72) Inventors: Insoo HWANG, San Diego, CA (US); Bongyong SONG, San Diego, CA (US); Won-ick LEE, San Diego, CA (US)

(21) Appl. No.: 15/182,251

(22) Filed: Jun. 14, 2016

Related U.S. Application Data
(60) Provisional application No. 62/387,406, filed on Dec. 23, 2015.

(51) Int. Cl. H04W 28/04; H04W 72/08; H04B 1/10; H04W 72/04

(52) U.S. Cl. CPC H04W 28/048; H04W 72/0446; H04W 72/082; H04B 1/1027

(57) ABSTRACT

Various aspects described herein relate to interference cancellation. A received signal is received at a receiver chain, where the received signal is interfered by an aggressor signal transmitted using a transmitter chain. In a second portion of a time interval, one or more cancellation coefficients can be updated based on a measurement made in a first portion of the time interval, where the time interval can be within a protocol time interval of a protocol used by the transmitter chain. Based on the one or more updated cancellation coefficients, interference cancellation is performed to cancel interference of the aggressor signal from the received signal.

### CLAIM OF PRIORITY UNDER 35 U.S.C. §119

The present Application for Patent claims priority to Provisional Application No. 62/387,406 entitled “ANALOG INTERFERENCE CANCELLATION USING DIGITAL COMPUTATION OF CANCELLATION COEFFICIENTS” filed Dec. 23, 2015, which is assigned to the assignee hereof and hereby expressly incorporated by reference herein for all purposes.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, time division synchronous code division multiple access (TD-SCDMA) systems, and Long Term Evolution (LTE), which is a set of enhancements to the Universal Mobile Telecommunications System (UMTS) mobile standard promulgated by Third Generation Partnership Project (3GPP).

These multiple access technologies have been adopted in various telecommunication standards to provide a common protocol that enables different wireless devices to communicate on a municipal, national, regional, and even global level. Generally, a wireless multiple-access communication system can simultaneously support communication for multiple wireless terminals (e.g., user equipment (UE)), each of which can communicate with one or more base stations over downlink or uplink resources.

In some LTE (or other wireless communication technology) configurations, user equipment (UE) can be provided with multiple antennas to concurrently transmit and/or receive communications with a base station. Due to close proximity of the antennas and related radio frequency (RF) resources within the UE, transmission from the UE (referred to as an aggressor signal) may interfere with reception of one or more signals at the UE. Accordingly, the UEs can utilize some mechanisms to cancel the interference at the receiver. In digitally controlled analog cancellation, cancellation coefficients for cancelling the interference are generated by estimating an interference gradient in the baseband over multiple measurement cycles, and applied to received signals to cancel interference from an aggressor signal. Accurate interference gradient estimation can require stationary interference for at least two measurement cycles. If aggressor interference statistics change during a gradient estimation cycle, gradient estimation can become inaccurate and coefficient generation can be affected. In addition, aggressor interference statistics can change in a duration as short as one subframe duration (e.g., in LTE).

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an example, a method for interference cancellation is provided. The method includes receiving a received signal at a receiver chain, where the received signal is interfered by an aggressor signal transmitted using a transmitter chain. The method also includes updating, in a second portion of a time interval, one or more cancellation coefficients based on a measurement made in a first portion of the time interval, where the time interval is within a protocol time interval of a protocol used by the transmitter chain. Further, the method includes performing, based on the one or more updated cancellation coefficients, interference cancellation to cancel interference of the aggressor signal from the received signal.

In another example, an apparatus for interference cancellation is provided. The user equipment includes a transmitter antenna coupled to one or more components of a transmitter chain of a RF front end configured to transmit an aggressor signal, a receiver antenna coupled to one or more components of a receiver chain of the RF front end configured to receive a received signal and the aggressor signal, at least one processor communicatively coupled with the transmitter chain and the receiver chain for communicating signals in a wireless network, and a memory communicatively coupled with the at least one processor. The at least one processor and the memory are operable to receive, via the receiver antenna, a received signal at the receiver chain, where the received signal is interfered by an aggressor signal transmitted using the transmitter chain, update, in a second portion of a time interval, one or more cancellation coefficients based on a measurement made in a first portion of the time interval, where the time interval is within a protocol time interval of a protocol used by the transmitter chain, and perform, based on the one or more updated cancellation coefficients, interference cancellation to cancel interference of the aggressor signal from the received signal.

In a further example, an apparatus is provided for interference cancellation. The user equipment includes means for receiving a received signal at a receiver chain, where the received signal is interfered by an aggressor signal transmitted using a transmitter chain, means for updating, in a second portion of a time interval, one or more cancellation coefficients based on a measurement made in a first portion of the time interval, where the time interval is within a protocol time interval of a protocol used by the transmitter chain, and means for performing, based on the one or more updated cancellation coefficients, interference cancellation to cancel interference of the aggressor signal from the received signal.

Moreover, in an example, a computer-readable storage medium is provided including code executable by a computer for interference cancellation. The code includes code for receiving a received signal at a receiver chain, where the received signal is interfered by an aggressor signal transmitted using a transmitter chain, code for updating, in a second portion of a time interval, one or more cancellation coefficients based on a measurement made in a first portion of the time interval, where the time interval is within a protocol time interval of a protocol used by the transmitter chain, and code for performing, based on the one or more updated cancellation coefficients, interference cancellation to cancel interference of the aggressor signal from the received signal.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The accompanying drawings are presented to aid in the description of various aspects of the disclosure and are provided solely for illustration of the aspects and not limitation thereof. The drawings include like reference numbers for like elements, and may represent optional components or actions using dashed lines.

FIG. 1 is a block diagram illustrating an example wireless communications systems including a user equipment having an RF front end and one or more processors configured to perform digitally controlled analog interference cancellation, according to aspects described herein.

FIGS. 2 and 3 depict flow diagrams of example methods for updating cancellation coefficients for performing interference cancellation in accordance with aspects described herein.

FIGS. 4 and 5 are block diagrams conceptually illustrating example subframe configurations for measuring cost functions and updating cancellation coefficients in accordance with aspects described herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts. Also, the terms “component” as used herein may be one of the parts that make up a system, may be hardware, firmware, and/or software, and may be divided into other functions.

Described herein are various aspects related to measuring an interference gradient estimated based on a cost function and accordingly updating cancellation coefficients for performing interference cancellation. The interference gradient can be estimated, and/or the cancellation coefficients can be updated, during a time interval over which interference statistics from an aggressor signal are expected to be substantially constant (e.g., stationary). In an example, the time interval may correspond to a protocol time interval of a protocol used by a transmitter of the aggressor signal (e.g., a transmission time interval (TTI) for a radio access technology RAT associated with the aggressor signal), a time interval during which a power amplifier for transmitting the aggressor signal is active, etc.). For instance, the time interval may include a transmission cycle determined for a transmitter of the aggressor signal. In addition, for example, measuring a cost function, as described herein, can relate to measuring one or more specific parameters (e.g., signal energy measurements) and calculating a cost function or related cost function interference gradient from the one or more specific parameters. In an example, interference statistics can refer to one or more measures of interference of the aggressor signal and/or of the received signal as impacted by the aggressor signal (e.g., signal-to-interference-and-noise ratio (SINR), signal-to-noise ratio (SNR), etc.). An aggressor signal, in an example, can refer to a signal transmitted by a transmitter chain of a radio frequency (RF) front end of a device (e.g., a user equipment (UE) in a wireless network) that interferes with signals received at the same device (e.g., signals received by a receiver chain in the RF front end of the device).

Where the aggressor signal corresponds to a third generation partnership project (3GPP) long term evolution (LTE) transmission, for example, interference caused by transmission of the aggressor signal can be substantially the same over a given subframe (e.g., the TTI in LTE), but may change from subframe-to-subframe (e.g., based on resource configuration of the UE, such as where the UE is configured to transmit in one subframe but not in another subframe). Thus, in an example, where the aggressor signal corresponds to an LTE transmission, an interference gradient estimated based on a cost function can be measured (e.g., based on perturbing one or more cancellation coefficients) within the subframe, and/or the one or more cancellation coefficients can be updated within a subframe. In a specific example, the interference gradient of the cost function can be measured in a first slot of the subframe, and the one or more cancellation coefficients can be updated in a second slot of the subframe. In another example, the cost function can be measured in a second slot of the subframe, while the cancellation coefficient is being updated. In digitally controlled analog interference cancellation, the one or more updated coefficients can be used in generating a cancellation signal that is injected into the receiver chain to cancel interference from the aggressor signal.

In another example, where the UE communicates using a time division duplexing (TDD) configuration, the cost function can be measured in one TDD uplink subframe and the cancellation coefficients can be updated in a next TDD non-uplink (e.g., downlink) subframe for applying to cancel interference in a subsequent TDD uplink subframe. Moreover, for example, other aggressor signals can be cancelled from received signals as well, such as Institute of Electrical and Electronics Engineers (IEEE) 802.11 (Wi-Fi) signals. In this example, an estimated interference gradient of the cost function can be measured, and one or more cancellation coefficients can be updated, during a time interval where a power amplifier (PA) in the transmitter chain is determined to be powered on. Furthermore, it is possible that the aggressor signal and received signals are based on a different timestamp and/or clock, and thus synchronization may occur to improve interference cancellation. Blind and independent measurement of the aggressor signal and received signal can be possible depending on the receiver's measurement capability.

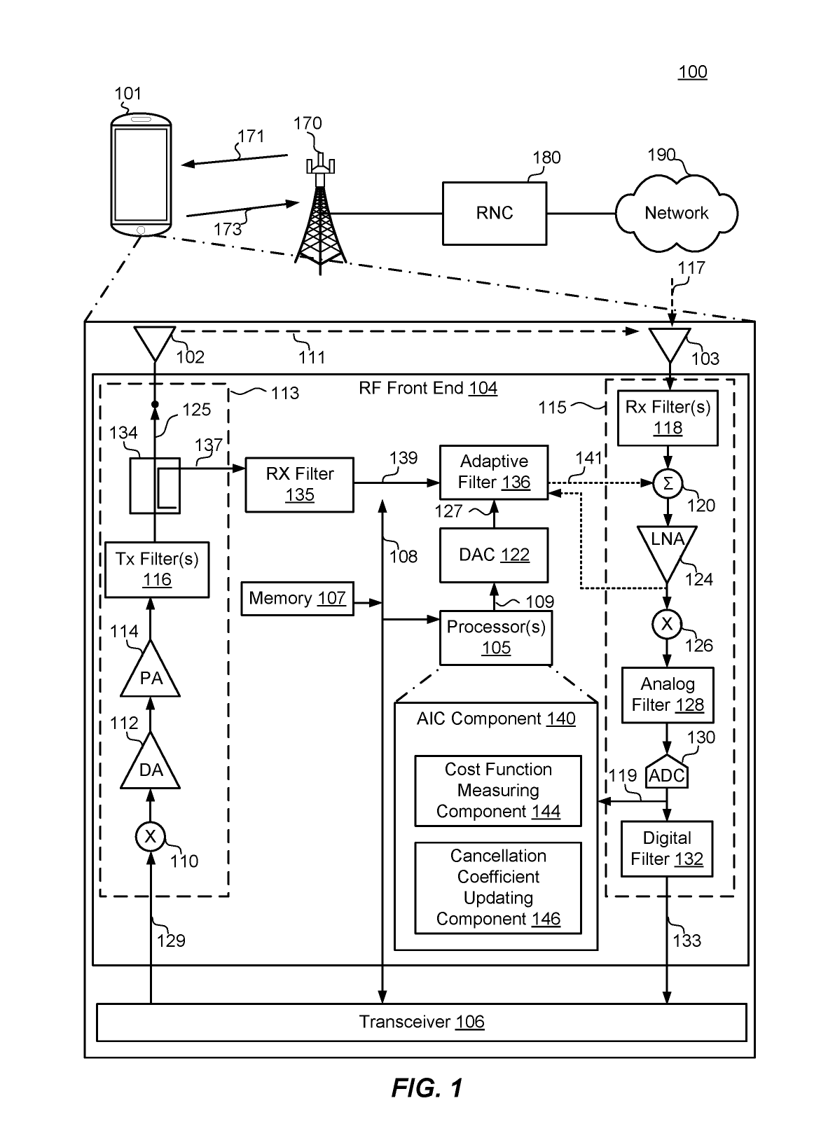

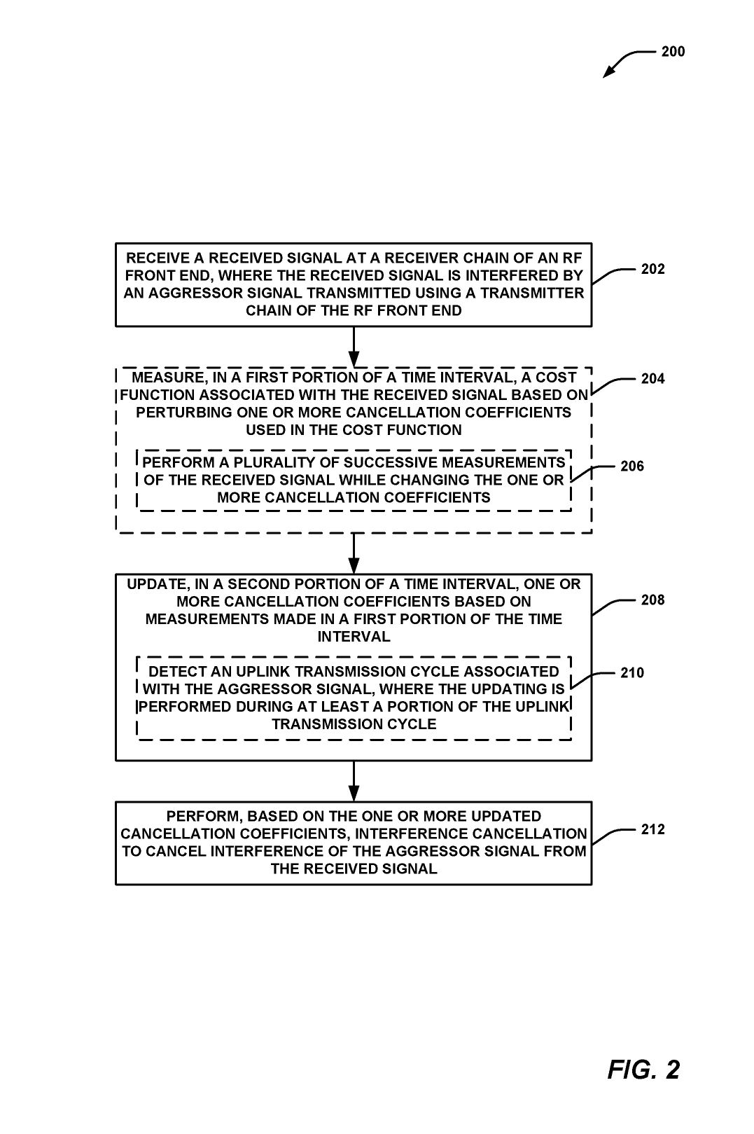

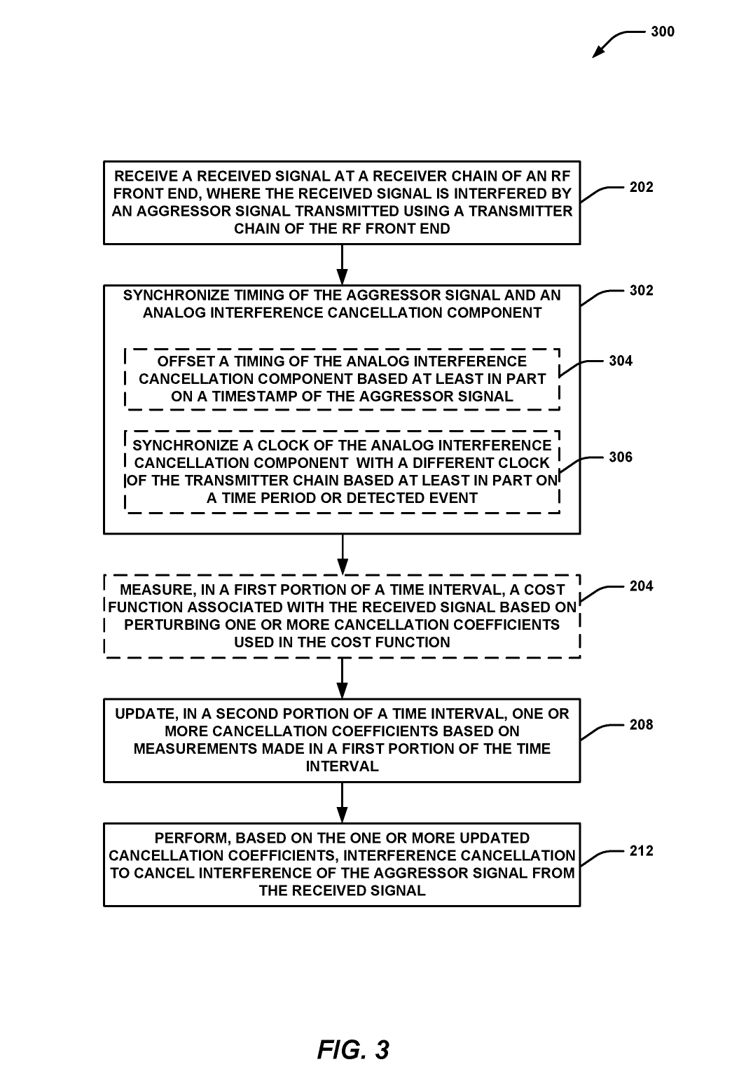

Referring to FIGS. 1-3, aspects are depicted with reference to one or more components, etc., and one or more methods that may perform the actions described herein. Although the operations described below in FIGS. 2 and 3 are presented in a particular order and/or as being performed by an example component, etc., it should be understood that the ordering of the actions and the components performing the actions may be varied, depending on the implementation. Moreover, it should be understood that the following actions may be performed by a specially-programmed processor, a processor executing specially-programmed software or computer-readable media, or by any other combination of a specially-programmed or configured hardware component and/or a specially-programmed or configured software component capable of performing the described actions.

FIG. 1 illustrates a wireless communication system 100 including a UE 101 in communication coverage of a network entity 170 (e.g., a base station or node B (NodeB or NB) providing one or more cells). UE 101 can include an example RF front end 104 configured to perform digitally controlled analog interference cancellation, as described herein, though it is to be appreciated that the various components and/or related functions described herein can be applied to other digitally controlled analog interference cancellation architectures. UE 101 can communicate with a network 190 via network entity 170 and/or a radio network control (RNC) 180. In an aspect, UE 101 may have established one or more uplink channels 173 for sending control and/or data transmissions (e.g., signaling) to network entity 170, and one or more downlink channels 171 for receiving control and/or data messages (e.g., signaling) from network entity 170 over configured communication resources (e.g., time and/or frequency resources).

In an aspect, UE 101 may include one or more processors 105 and/or a memory 107 that may be communicatively coupled, e.g., via one or more buses 108 (e.g., along with one or more other components of UE 101), and may operate in conjunction with or otherwise implement an analog interference cancellation (AIC) component 140 for computing one or more cancellation coefficients to generate an interference cancellation signal. For example, AIC component 140 may execute various components, or operate in conjunction with various components, for generating or updating one or more cancellation coefficients 109 based on sampling a digital representation 119 of a received signal 117 that may be interfered by an aggressor signal 111. For example, the transmitted aggressor signal 111 may interfere with one or more received signals 117 (also referred to as “victim signals”) received at receiver antenna 103. Accordingly, in an example, the updated cancellation coefficients 109 can be provided to a DAC 122 for converting to an analog representation of the cancellation coefficients 127, which can be provided to adaptive filter 136. Adaptive filter 136 can multiply the analog representation of the cancellation coefficients 127 with a reference signal 137 from the transmitter chain 113 to generate an analog interference cancellation signal 141 for adding to the received signal 117 to cancel interference therefrom that may be caused by the aggressor signal 111. For example, adaptive filter 136 can multiply the analog representation of the cancellation coefficients 127 to a filtered reference signal 139 from an Rx filter 135, where the filtered reference signal 139 corresponds to the reference signal 137 from the transmitter chain 113 (which may be a reference of aggressor signal 111) filtered based on a baseband of the receiver chain 115 via Rx filter 135.

In an aspect, for example, transmitted aggressor signal 111 may be any signal transmitted by transmitter antenna 102 or generated for transmission by one or more components of transmitter chain 113. Further, in an aspect, for example, received signal 117 may be any over-the-air signal received concurrently with transmitted aggressor signal 111 by receiver antenna 103 and communicated to receiver chain 115, where the ability of UE 101 to decode received signal 117 may be affected due to interference from also receiving transmitted aggressor signal 111.

The various specially configured actions related to AIC component 140 may be implemented or otherwise executed by one or more processors 105 and, in an aspect, can be executed by a single processor, while in other aspects, different ones of the functions may be executed by a combination of two or more different processors. For example, in an aspect, the one or more processors 105 may include any one or any combination of a modem processor, a baseband processor, a digital signal processor, a field-programmable gate array (FPGA), an application specific integrated circuit (ASIC), a transmit processor, a transceiver processor associated with transceiver 106, etc. Further, for example, the memory 107 may be a non-transitory computer-readable medium that includes, but is not limited to, random access memory (RAM), read only memory (ROM), programmable ROM (PROM), erasable PROM (EPROM), electrically erasable PROM (EEPROM), a magnetic storage device (e.g., hard disk, floppy disk, magnetic strip), an optical disk (e.g., compact disk (CD), digital versatile disk (DVD)), a smart card, a flash memory device (e.g., card, stick, key drive), a register, a removable disk, and any other suitable medium for storing software and/or computer-readable code or instructions that may be accessed and read by a computer or one or more processors 105. Moreover, memory 107 or computer-readable storage medium may be resident in the one or more processors 105, external to the one or more processors 105, or distributed across multiple entities including the one or more processors 105.

In particular, the one or more processors 105 and/or memory 107 may execute actions described herein with respect to AIC component 140 and/or its subcomponents. For instance, the one or more processors 105 and/or memory 107 may execute actions or operations defined by a cost function measuring component 144 for performing a plurality of cost function measurements of a digital representation 119 of a received signal 117 that may be interfered by an aggressor signal 111, where one or more cancellation coefficients can be perturbed in performing the measurements to estimate an interference gradient. In an aspect, for example, cost function measuring component 144 may include hardware (e.g., one or more processor modules of the one or more processors 105) and/or computer-readable code or instructions stored in memory 107 and executable by at least one of the one or more processors 105 to perform the specially configured cost function measuring operations described herein. Further, for instance, the one or more processors 105 and/or memory 107 may execute actions or operations defined by a cancellation coefficient updating component 146 for updating one or more cancellation coefficients 109 corresponding to digital representation 119 of the received signal 117 based on the estimated interference gradient for use in generating an interference cancellation signal. In an aspect, for example, cancellation coefficient updating component 146 may include hardware (e.g., one or more processor modules of the one or more processors 105) and/or computer-readable code or instructions stored in memory 107 and executable by at least one of the one or more processors 105 to perform the specially configured cancellation coefficient updating operations described herein. Further in an example, a DAC 122 may convert the one or more cancellation coefficients 109 to analog representation of the cancellation coefficients 127 for providing to adaptive filter 136 for multiplying with a reference signal to generate an interference cancellation signal, as described.

Moreover, in an aspect, UE 101 may include RF front end 104 and transceiver 106 for receiving and transmitting radio signals. For example, transceiver 106 may communicate with the one or more processors 105 or other processors (not shown) to obtain signals for transmitting via RF front end 104 and/or to provide signals received via RF front end 104 for processing. RF front end 104 may be connected to one or more antennas, which may include at least a transmitter antenna 102 and a receiver antenna 103 (though additional transmitter and/or receiver antennas can be provided in UE 101). RF front end 104 may include various components of transmitter chain 113 connected to transmitter antenna 102 and receiver chain 115 connected to receiver antenna 103. For example, the transmitter chain 113 may include one or more of a mixer 110, distributed amplifier (DA) 112, PA 114, Tx filter(s) 116, a coupler 134, etc., to generate a transmit signal, which may include aggressor signal 125 for transmitting (e.g., over uplink channel 173) via transmitter antenna 102, and/or a reference signal 137. The receiver chain 115, in an example, may include one or more of a Rx filter(s) 118, a summer 120 to add analog interference cancellation signal 141 to a received signal in some examples (such as received signal 117), a low-noise amplifier (LNA) 124, a mixer 126, an analog filter 128, an ADC 130, a digital filter 132, etc. to facilitate receiving (e.g., over downlink channel 171) signals, which may include received signal 117 or signals from network entity 170, in wireless communications.

As described further herein, Rx filter 118 can filter the received signals 117 to a baseband of the receiver chain 115, and Rx filter 135 can similarly filter reference signals 137 to a baseband of the receiver chain 115. The “baseband” can correspond to a frequency band over which the receiver chain 115 is to receive signals, and the Rx filter 118 can filter received victim signals 117 (and/or Rx filter 135 can filter reference signals 137) at the frequency band. In an example, summer 120 can add an analog interference cancellation signal 141 from the adaptive filter 136 to the received victim signal 117 to generate a received signal with a transmitted aggressor signal 111 cancelled therefrom. LNA 124, mixer 126, analog filter 128, ADC 130, and digital filter 132 can be applied to the signal to produce a digital received signal 133 for providing to transceiver for processing at higher network layers. In addition, the digital representation 119 of the received signal 117 can be provided to the AIC component 140 for measuring the cost function and updating associated cancellation coefficients, as described herein. Moreover, as described herein, AIC component 140, and/or components thereof, can measure the cost function and/or update cancellation coefficients within a time interval during which interference statistics are expected to be substantially constant (e.g., during a TTI, such as a subframe in LTE, during a time interval where a PA is active in Wi-Fi, during a determined transmission cycle, etc.).

In an example, transmitter antenna 102 can transmit signals while receiver antenna 103 is concurrently and/or simultaneously receiving signals (e.g., over a same or different frequency band, which may overlap in frequency), such that signals transmitted over transmitter antenna 102 may cause interference to signals received over receiver antenna 103. In this regard, AIC component 140 in combination with DAC 122 can generate an analog interference cancellation signal 141 based on signals (e.g., transmitted aggressor signal 111) being transmitted over transmitter antenna 102 for adding into the receiver chain 115 to cancel interference caused to other received signals (e.g., victim signal 117) that are being concurrently received by receiver antenna 103. In another example, least means squared (LMS) analog cancellation may be achieved by providing the received signals 117 from LNA 124 to the adaptive filter 136, where the adaptive filter 136, in this example, can be configured to perform correlation in generating analog coefficients for applying to the filtered reference signal 139 and generating analog interference cancellation signal 141.

Moreover, it is to be appreciated, for example, that components of RF front end 104 can connect with transceiver 106 (e.g., LNAs 124, PAs 114, DA 112, mixers 110, 126, filters 116, 118, 128, 132, ADC 130, etc.) for providing to additional components of the UE 101 (e.g., one or more additional processors for processing related communications at higher network communication layers, etc.). RF front end 104 can support communications over multiple bands via the multiple filters 116 and/or 118, LNAs 124, and/or PAs 114. Thus, for example, each filter 116 and/or 118 can relate to a certain frequency band within which the RF front end 104 can transmit or receive signals.

In an aspect, LNA 124 (and/or 154) can amplify a received signal at a desired output level. In an aspect, each of one or more LNAs 124 may have a specified minimum and maximum gain values for amplifying the received signals. In an aspect, RF front end 104 may use one or more switches to select a particular filter 118 path to an LNA 124. For example, the RF front end 104 may utilize a particular filter 118/LNA 124 based on the specified gain value of the LNA 124 and/or a desired gain value for a particular application.

Further, for example, one or more PA(s) 114 may be used by RF front end 104 to amplify a signal for an RF output transmission at a desired output power level. In an aspect, each PA 114 may similarly have a specified minimum and maximum gain values. In an aspect, RF front end 104 may use one or more switches to select a particular filter 116 path and an associated PA 114 to achieve a desired gain value for a particular application based on the gain value of the PA 114.

Transceiver 106 may be configured to transmit and receive wireless signals through the transmitter antenna 102 and receiver antenna 103, respectively, (and/or other antennas) via RF front end 104. In an aspect, transceiver 106 may be tuned to operate at specified frequencies such that UE 101 can communicate with, for example, network entity 170 at a certain frequency. In an aspect, the one or more processors 105, and/or other processors of UE 101, may configure transceiver 106 to operate at a specified frequency and power level based on the UE configuration of the UE 101 and/or a communication protocol.

In an aspect, transceiver 106 can operate in multiple bands (e.g., using a multiband-multimode modem, not shown) such to process digital data sent and received using transceiver 106. In an aspect, transceiver 106 can be multiband and can be configured to support multiple frequency bands for a specific communications protocol. In an aspect, transceiver 106 can be configured to support multiple operating networks and communications protocols. Thus, for example, transceiver 106 may enable transmission and/or reception of signals from the network based on a specified modem configuration. In an aspect, configuration of the transceiver 106 in this regard can be based on UE configuration information associated with UE 101 as provided by the network during cell selection and/or cell reselection.

In some aspects, UE 101 may also be referred to by those skilled in the art (as well as interchangeably herein) as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. A UE 101 may be a cellular phone, a personal digital assistant (PDA), a wireless modem, a wireless communication device, a handheld device, a tablet computer, a laptop computer, a cordless phone, a wireless local loop (WLL) station, a global positioning system (GPS) device, a multimedia device, a video device, a digital audio player (e.g., MP3 player), a camera, a game console, a wearable computing device (e.g., a smart-watch, smart-glasses, a health or fitness tracker, etc), an appliance, a sensor, a vehicle communication system, a medical device, a vending machine, or any other similar functioning device.

It is to be appreciated, in an aspect, other devices in the wireless communication system 100, such as network entity 170, can include and implement AIC component 140. For instance, network entity 170 can be similarly configured to perform digitally driven analog interference cancellation at an RF front end using an AIC component 140.

FIG. 2 illustrates an example method 200 for performing (e.g., by a UE or other wireless network entity) interference cancellation based on measuring a cost function and updating cancellation coefficients during a time interval when interference statistics are expected to be substantially constant. Method 200 includes, at Block 202, receiving a received signal at a receiver chain of an RF front end, where the received signal is interfered by an aggressor signal transmitted using a transmitter chain of the RF front end. In an aspect, receiver chain 115 of RF front end 104 in FIG. 1 can receive the received signal 117 (e.g., from receive antenna 103), where the received signal 117 is interference by an aggressor signal 111 transmitted using the transmitter chain 113 of RF front end 104. As described, the RF front end 104 creates the interference by transmitting aggressor signal 111 over a frequency band that is near and/or overlaps a frequency band related to received signal 117. Accordingly, RF front end 104 includes various components to cancel the interference based on obtaining a reference signal 137 of the aggressor signal 111 from the transmitter chain 113 (e.g., from a coupler 134 that receives an output of TX filter 116) and applying an analog representation of cancellation coefficients 127 to a filtered reference signal 139 of the reference signal 137 to generate an analog interference cancellation signal 141 for applying to the received signal 117. For example, digitally controlled analog interference cancellation can be used to cancel the interference, as described herein. Thus, receiving the received signal at Block 202 may include receiving a digital representation of the received signal (e.g., AIC component 140 can receive digital representation 119 of the received signal 117 from ADC 130 in the receiver chain 115, which may include one or more in-phase (I)/quadrature (q) samples of the received signal 117).

Method 200 also optionally includes, at Block 204, measuring, in a first portion of a time interval, a cost function associated with the received signal based on perturbing one or more cancellation coefficients used in the cost function. In an aspect, cost function measuring component 144, e.g., in conjunction with processor(s) 105 and/or memory 107, can measure, in the first portion of the time interval, the cost function associated with the received signal based on perturbing one or more cancellation coefficients used in the cost function. For example, measuring the cost function can include accumulating energy measured of the received signal at a measurement window, which may include, during the measurement window, taking an average power of the sampled signals with linear or exponential weighting, etc. As described, for example, measuring the cost function may include measuring the accumulated energy of the received signal at the measurement window, and calculating a cost function based on the accumulated energy. As another example, measuring the cost function can include filtering the received signal 117 at a measurement window, which may include applying a particular type of filtering to the sampled signals, e.g., band-pass filtering, low-pass filtering, high-pass filtering, etc. In an example, where cost function measuring component 144 determines that a specific sub-band has a particularly strong aggressor signal relative to the desired received signal strength in the sub-band, cost function measuring component 144 can apply a band-pass filter for passing the specific sub-band. In an example, an average power of the filtered signal may be used as a cost function.

In addition, measuring the cost function at Block 204 may optionally include, at Block 206, performing a plurality of successive measurements of the received signal (e.g., over the measurement window) while changing the one or more cancellation coefficients. In an aspect, cost function measuring component 144 can additionally perform the plurality of successive measurements of the received signal 117 (e.g., the digital representation 119 of the received signal 117) while changing (e.g., perturbing) the one or more cancellation coefficients. Cost function measuring component 144 can accordingly estimate an interference gradient of the cost function (e.g., the one or more values output by determining or computing the cost function) based on perturbing the one or more cancellation coefficients.

Method 200 also includes, at Block 208, updating, in a second portion of a time interval, one or more cancellation coefficients based on measurements made in a first portion of the time interval. In an aspect, cancellation coefficient updating component 146, e.g., in conjunction with processor(s) 105 and/or memory 107, can update, in the second portion of the time interval, the one or more cancellation coefficients based on measurements made in the first portion of the time interval. In an example, the measurements made during the first portion of the time interval can include the measuring of the cost function as performed by cost function measuring component 144 (e.g., in Block 204). Additionally, as described, the time interval can relate to a period of time over which interference statistics of a signal (e.g., the aggressor signal) are substantially stationary. For example, this time interval may include a period of time over which transmit power used by the transmitter chain 113 is substantially constant (or determined to be substantially constant), and thus the interference statistics at the receiver chain 115 may be substantially stationary. For example, the time interval may correspond to a protocol time interval of a protocol used by the transmitter chain (e.g., in transmitting the aggressor signal), such as a TTI of a RAT (e.g., a subframe in LTE), a frame duration of a RAT, a slot duration of a RAT, a symbol duration of a RAT, a time during which a PA of the transmitter chain 113 is determined to be active (e.g., to determine a time interval for Wi-Fi), a time during which a PA gain of the transmitter chain 113 is determined to be fixed, and/or the like. As described, the protocol used by the transmitter chain 113 in transmitting the aggressor signal 111 may not be the same as the protocol used by the receiver chain 115 in receiving the signal, but the cost function measuring component 144 may measure the cost function and/or related parameters (e.g., signal energy) in a time interval that corresponds to the protocol used by the transmitter chain 113. In one specific example, as described, the transmitter chain 113 may transmit the aggressor signal 111 using Wi-Fi while the receiver chain 115 receives the aggressor signal as interference to an LTE communication.

In an example, cancellation coefficient updating component 146 can determine effective cancellation coefficients to cancel interference of aggressor signal 111 from received signal 117 based on perturbing the coefficients and performing the associated cost function measurements, as described in examples herein. Moreover, for example, where cost function measuring component 144 estimates an interference gradient, cancellation coefficient updating component 146 can determine effective cancellation coefficients based on the estimated interference gradient (e.g., based on negative gradient direction based on comparing cost functions with different cancellation coefficient perturbations). Specifically, if an increment of a coefficient results in an increase of the cost function (e.g., at least a threshold increase), the cancellation coefficient updating component 146 may decide to decrease the coefficient. On the other hand, if an increment of a coefficient results in a decrease of the cost function (e.g., at least a threshold decrease), the cancellation coefficient updating component 146 may decide to increase the coefficient. This approach for changing the coefficients in accordance with the (estimated) negative gradient direction can be generalized to update multiple coefficients. As an example, if an increment of one coefficient results in an increase of the cost function and an increment of another coefficient results in a decrease of the cost function, the cancellation coefficient updating component 146 may decide to decrease the first coefficient and to increase the second coefficient. The step size of increasing and decreasing the coefficients can be either a fixed step size or a variable step size.

For example, cost function measuring component 144 can measure the cost function, and cancellation coefficient updating component 146 can update the one or more cancellation coefficients in the time interval where the time interval corresponds to a time interval over which interference statistics of an aggressor signal (e.g., aggressor signal 111) are substantially constant. For example, in LTE, interference statistics of an aggressor signal can be substantially constant over a subframe, but may change from subframe to subframe (e.g., based on an uplink resource configuration of the UE). Accordingly, in this example, the time interval can correspond to a subframe (e.g., of the aggressor signal), and thus cost function measuring component 144 can measure the cost function in a first portion of the aggressor signal subframe, and cancellation coefficient updating component 146 can update the one or more cancellation coefficients in a second portion of the aggressor signal subframe. In one specific example, the first portion of the subframe may correspond to a first slot of the subframe, and the second portion of the subframe may correspond to a second slot of the subframe. For example, a subframe in LTE can include 12 or 14 OFDM symbols depending on whether extended or normal cyclic prefix is used, and in these examples, each slot can include 6 or 7 OFDM symbols (e.g., a half of the subframe), respectively.

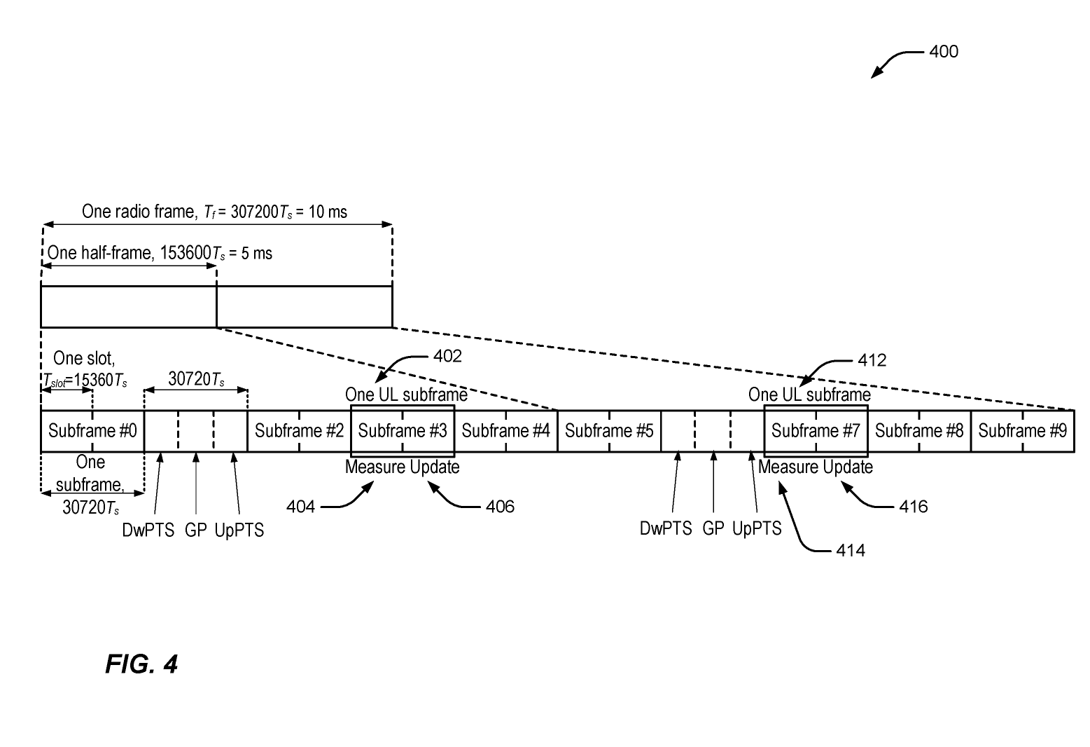

An example in LTE is shown in FIG. 4, which depicts a timeline 400 corresponding to a UE configured to communicate according to a TDD configuration, where subframe 3 402 and subframe 7 412 are configured for uplink communications. Accordingly, cost function measuring component 144 can measure the cost function (e.g., measure an interference gradient estimated based on calculating the cost function), as described, in slot 0 404 of subframe 3 402 of the aggressor signal (e.g., where slot 0 404 is the first portion of the time interval and subframe 3 402 is the time interval), and cancellation coefficient updating component 146 can update the one or more cancellation coefficients based on the measured cost function (e.g., based on the interference gradient) in slot 1 406 of subframe 3 402 (e.g., where slot 1 406 is the second portion of the time interval and subframe 3 402 is the time interval) for cancelling interference of the aggressor signal 111 from one or more received signals 117 (e.g., as received in uplink subframe 402 using a different RAT, using a different FDD/TDD configuration, subframe configuration, etc.).

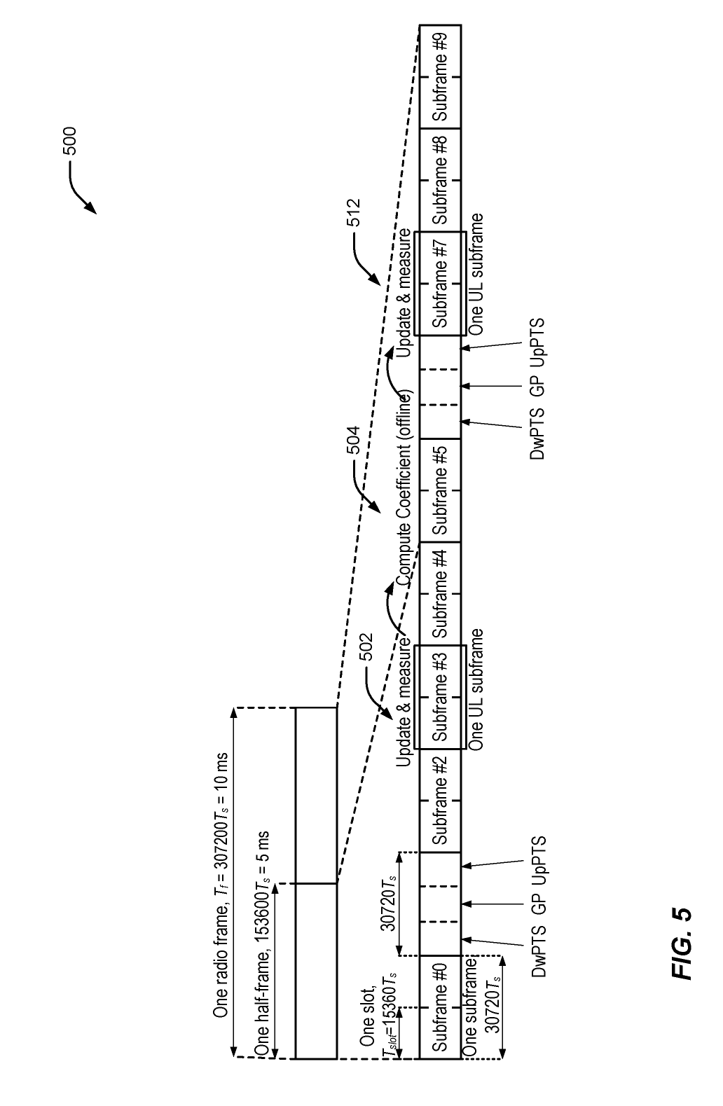

Another example in LTE is shown in FIG. 5, which depicts a timeline 500 corresponding to a UE configured to communicate according to a TDD configuration, where subframe 3 502 and subframe 7 512 are configured for uplink communications. In this example, it may be assumed that the interference statistics of aggressor signals 111 from the transmitter chain 113 are similar in consecutive TDD uplink subframes. Thus, for example, in subframe 3 502, cancellation coefficient updating component 146 can update the one or more cancellation coefficients (e.g., based on previously computed coefficients from cost function measurements of an estimated interference gradient in a previous uplink subframe), and cost function measuring component 144 can measure the cost function (e.g., based on an interference gradient estimate), as described, based on (e.g., and/or by perturbing) the updated cancellation coefficients. Cancellation coefficient updating component 146 can perform the computation of updated cancellation coefficients based on the cost function in one or more non-uplink subframes (e.g., off-line), and can then update the cancellation coefficients in the next uplink subframe (e.g., subframe 7 512) for performing interference cancellation for received signals 117 as described (and for performing cost function measurements for updating coefficients in the next uplink subframe after subframe 7 512).

In another example, in Wi-Fi, the time interval can correspond to when a power amplifier (e.g., PA 114, where transmitter chain 113 corresponds to transmitting Wi-Fi signals) is determined to be activated (which can indicate possible aggressor signal 111 transmission). Accordingly, cost function measuring component 144 can measure the cost function (e.g., based on an interference gradient estimate) and cancellation coefficient updating component 146 can update the one or more cancellation coefficients based on the measured cost function during the time interval when it is determined that the power amplifier is active.

In an example, updating the one or more cancellation coefficients at Block 208 may optionally include, at Block 210, detecting an uplink transmission cycle associated with the aggressor signal, where the updating is performed during at least a portion of the uplink transmission cycle. In an aspect, AIC component 140, e.g., in conjunction with processor(s) 105 and/or memory 107, can detect the uplink transmission cycle associated with the aggressor signal (e.g., aggressor signal 111), where cancellation coefficient updating component 146 can perform the updating during at least a portion of the uplink transmission cycle. For example, where transmitter chain 113 transmits aggressor signals 111 in LTE, AIC component 140 may detect the uplink transmission cycle (e.g., as the time interval over which interference statistics are substantially stationary) based on a configuration received from network entity 170 (e.g., an uplink/downlink subframe configuration in TDD, a resource grant, related frequency, transmit power, etc. for uplink communications where UE 101 is configured in FDD, and/or the like). For example, where transmitter chain 113 transmits aggressor signals 111 in Wi-Fi, AIC component 140 may detect the uplink transmission cycle based on detecting when PA 114 is active, determining a protocol time interval such as a TTI, etc., as described. In an example, cancellation coefficient updating component 146 can update the one or more cancellation coefficients and/or cost function measuring component 144 can measure the cost function based on detecting the uplink transmission cycle.

In a specific example, cost function measuring component 144 can measure the cost function, and cancellation coefficient updating component 146 can update the one or more cancellation coefficients based on a two-stage sign stochastic approximation (SSA). For example, cost function measuring component 144 can measure cost function C(w) associated with received signal w, can increase an in-phase (I) portion of the signal w by a step size Vstep (e.g., wi=w+Vstep), and can measure C(wi). In this example, cancellation coefficient updating component 146 can update the coefficient as follows: If C(wi)<C(w), set w=w+Vstep, or else set w=w−Vstep. Cost function measuring component 144 can then obtain a new C(w) with the updated w, can increase a quadrature (Q) portion of the updated signal w by Vstep (e.g., wq=w+j*Vstep), and can measure C(wq). In this example, cancellation coefficient updating component 146 can update the coefficient as follows: If C(wq)<C(w), set w=w+j*Vstep, or else set w=w−j*Vstep. As described, the measuring by cost function measuring component 144 can be performed in a first portion of a time interval (e.g., a first slot of a subframe), and updating the cancellation coefficients by cancellation coefficient updating component 146 can be performed in a second portion of the time interval (e.g., a second slot of the subframe).

Method 200 also includes, at Block 212, performing, based on the one or more updated cancellation coefficients, interference cancellation to cancel interference of the aggressor signal from the received signal. In an aspect, one or more components of RF front end 104, such as adaptive filter 136 and summer 120 can perform, based on the one or more updated cancellation coefficients, interference cancellation to cancel interference of the aggressor signal (e.g., aggressor signal 111) from the received signal (e.g., received signal 117). As described, for example, AIC component 140 and/or one or more components thereof can provide the updated cancellation coefficients 109 to DAC 122 for generating an analog representation of the cancellation coefficients 127, which can be provided to the adaptive filter 136. Adaptive filter 136, in this example, can multiply a filtered reference signal 139 received from transmitter chain 113 and filtered, by the analog representation of the cancellation coefficients in the analog domain to generate an analog interference cancellation signal 141. Adaptive filter 136 can inject the analog interference cancellation signal 141 into the receiver chain 115 (e.g., at summer 120) to cancel interference caused by the aggressor signal 111 based on the measured cost function and updated cancellation coefficients occurring in the same time interval. For example, cancelling interference can refer to mitigating, reducing, removing, minimizing, etc. the interference caused by the aggressor signal 111 by the effect of injecting the analog interference cancellation signal 141 in the received signal 117.

FIG. 3 illustrates an example method 300 for performing (e.g., by a UE or other wireless network entity) interference cancellation based on measuring a cost function and updating cancellation coefficients, as described herein, and accounting for time discrepancies between a transmitter chain and receiver chain in an RF front end. Method 300 includes, at Block 202, receiving a received signal at a receiver chain of an RF front end, where the received signal is interfered by an aggressor signal transmitted using a transmitter chain of the RF front end. In an aspect, as described, receiver chain 115 of RF front end 104 in FIG. 1 can receive the received signal 117 (e.g., from receive antenna 103), where the received signal 117 is interference by an aggressor signal 111 transmitted using the transmitter chain 113 of RF front end 104.

Method 300 also includes, at Block 302, synchronizing timing of the aggressor signal and an analog interference cancellation component. In an aspect, AIC component 140, e.g., in conjunction with processor(s) 105 and/or memory 107, can synchronize timing of the aggressor signal 111 and the AIC component 140. For example, the transmitter chain 113 and the receiver chain 115 may not be synchronized. Thus, to facilitate measuring the cost function and updating cancellation coefficients during the uplink transmission cycle corresponding to the aggressor signal 111 for cancelling interference of the aggressor signal 111, as described herein, synchronization of the AIC component 140 with the aggressor signal 111 may be desired. In an example, synchronizing timing at Block 302 may optionally include, at Block 304, offsetting a timing of the analog interference cancellation component based at least in part on a timestamp of the aggressor signal. In an aspect, AIC component 140 may offset its timing based at least in part on the timestamp of the aggressor signal 111. For example, AIC component 140 may increment or decrement its timing based on determining a difference between its timing and the timestamp indicated in the aggressor signal 111. This may be effective, for example, where the transmitter chain 113 transmitting aggressor signal 111 and AIC component 140 utilize a common clock (e.g., a clock of processor(s) 105).

Where the transmitter chain 113 and AIC component 140 utilize different clocks, however, periodic or event driven synchronization of the clocks may be desired. Thus, in an example, synchronizing the timing at Block 302 may optionally include, at Block 306, synchronizing a clock of the analog interference cancellation component with a different clock of the transmitter chain based at least in part on a time period or detected event. In an aspect, AIC component 140 can synchronize its clock (e.g., a clock of processor(s) 105) with the different clock of the transmitter chain 113 (e.g., a clock of one or more other processors thereof) based on the time period or detected event. For example, the time period may be received by network entity 170 or otherwise configured at the UE 101. Where the synchronization is based on a detected event, for example, the event may be specified in a configuration from the network entity 170 or may otherwise be configured at the UE 101, and may include an interrupt detected in the processor(s) 105 (e.g., one or more specific interrupts), a general purpose input/output (GPIO) received at processor(s) 105, a message from the transmitter chain 113 to the AIC component 140, etc. In addition, in an example, the detected event may include a coexistence manager (CxM) (e.g., to reduce the interference to the receiver using transmit signal power backoff, time coordination between the transmitter chain 113 and the receiver chain 115, and/or transmit signal blanking), time boundary indication (e.g., as given from a PA, such as PA 114, in the transmitter chain 113 or baseband so the receiver chain 115 may acknowledge the timing of aggressor signal's uplink transmission cycle, e.g., ON duration), transmit/receive indication control I/O signal for an external PA (e.g., PA 114, which may indicate activation thereof), control I/O for a switch where the transmitter chain 113 and the receiver chain 115 use a shared antenna, etc.

In any case, based on synchronizing timing of the AIC component 140 with the aggressor signal 111, method 300 can continue as described with respect to FIG. 2, which can optionally include, at Block 204, measuring, in a first portion of a time interval, a cost function associated with the received signal based on perturbing one or more cancellation coefficients used in the cost function. Method 300 can also include, at Block 208, updating, in a second portion of a time interval, one or more cancellation coefficients based on measurements made in a first portion of the time interval. As described, the measurements made in the first portion of the time interval may correspond to the measurement of the cost function in Block 204. Additionally, in an example, performing Blocks 204 and 208 with a synchronized clock between the AIC component 140 and the aggressor signal 111 can allow for measuring and updating relevant cancellation coefficients (e.g., before interference statistics of the aggressor signal 111 change). Method 300 may also include, at Block 212, performing, based on the one or more updated cancellation coefficients, interference cancellation to cancel interference of the aggressor signal from the received signal, as described.

Several aspects of a telecommunications system have been presented with reference to an LTE system. As those skilled in the art will readily appreciate, various aspects described herein may be extended to other telecommunication systems, network architectures and communication standards.

By way of example, various aspects described herein may be extended to other UMTS systems such as W-CDMA, TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects described herein, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described herein. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the functionality described herein depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods or methodologies described herein may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described herein that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f) unless the element is expressly recited using the phrase “means for” or, in the case of a method claim, the element is recited using the phrase “step for.”

What is claimed is:

1. A method for interference cancellation, comprising:
receiving a received signal at a receiver chain, where the received signal is interfered by an aggressor signal transmitted using a transmitter chain;
updating, in a second portion of a time interval, one or more cancellation coefficients based on a measurement made in a first portion of the time interval, wherein the time interval is within a protocol time interval of a protocol used by the transmitter chain; and
performing, based on the one or more updated cancellation coefficients, interference cancellation to cancel interference of the aggressor signal from the received signal.

2. The method of claim 1, further comprising measuring, in the first portion of the time interval, a cost function associated with the received signal based on perturbing the one or more cancellation coefficients used in the cost function.

3. The method of claim 2, wherein the first portion of the time interval is a first half of the time interval, the second portion of the time interval is a second half of the time interval, and wherein updating the one or more cancellation coefficients and measuring the cost function occur in the same time interval.

4. The method of claim 2, wherein the first portion of the time interval is a first half of the time interval, the second portion of the time interval is a second half of the time interval, and further comprising additionally measuring a response of the cost function of perturbing the one or more cancellation coefficients in the second half of the time interval, wherein updating the one or more cancellation coefficients is based at least in part on additionally measuring the response of the cost function in the second half of the time interval.

5. The method of claim 1, wherein the protocol time interval corresponds to a transmission cycle during which power used by the transmitter chain is substantially constant.

6. The method of claim 1, wherein the protocol time interval corresponds to a transmission time interval (TTI).

7. The method of claim 6, wherein the TTI is a subframe.

8. The method of claim 7, wherein the first portion of the time interval is a first slot of the subframe, and the second portion of the time interval is a second slot of the subframe.

9. The method of claim 1, wherein the first portion of the time interval and the second portion of the time interval correspond to one or more symbol durations of the aggressor signal.

10. The method of claim 1, further comprising detecting an uplink transmission cycle associated with the aggressor signal, wherein at least updating the one or more cancellation coefficients is performed during at least a portion of the uplink transmission cycle.

11. The method of claim 10, wherein detecting the uplink transmission cycle is based at least in part on a subframe configuration received from a network entity.

12. The method of claim 10, wherein detecting the uplink transmission cycle is based at least in part on determining whether a power amplifier is activated during one or more portions of the uplink transmission cycle.

13. The method of claim 1, wherein the protocol time interval corresponds to a period of time during which a power amplifier is determined to be active.

14. The method of claim 1, wherein an analog interference cancellation component performs the interference cancellation, and further comprising synchronizing timing of the aggressor signal and the analog interference cancellation component.

15. The method of claim 14, wherein the synchronizing comprises offsetting a timing of the analog interference cancellation component based at least in part on a timestamp of the aggressor signal, wherein the analog interference cancellation component and the transmitter chain utilize a common clock.

16. The method of claim 14, wherein the synchronizing comprises synchronizing a clock of the analog interference cancellation component with a different clock of the transmitter chain based at least in part on a time period or an event detected at the analog interference cancellation component.

17. The method of claim 16, wherein the event includes at least one of an interrupt, a general purpose input/output (GPIO), or a message from the transmitter chain.

18. An apparatus for interference cancellation, comprising:
a transmitter antenna coupled to one or more components of a transmitter chain of a radio frequency (RF) front end configured to transmit an aggressor signal;
a receiver antenna coupled to one or more components of a receiver chain of the RF front end configured to receive a received signal and the aggressor signal;
at least one processor communicatively coupled with the transmitter chain and the receiver chain for communicating signals in a wireless network; and
a memory communicatively coupled with the at least one processor;
wherein the at least one processor is operable to:
receive, via the receiver antenna, the received signal at the receiver chain, where the received signal is interfered by the aggressor signal transmitted using the transmitter chain;
update, in a second portion of a time interval, one or more cancellation coefficients based on a measurement made in a first portion of the time interval, wherein the time interval is within a protocol time interval of a protocol used by the transmitter chain; and
perform, based on the one or more updated cancellation coefficients, interference cancellation to cancel interference of the aggressor signal from the received signal.

19. The apparatus of claim 18, wherein the at least one processor is further operable to measure, in the first portion of the time interval where interference statistics of the aggressor signal are substantially stationary over the time interval, a cost function associated with the received signal based on perturbing the one or more cancellation coefficients used in the cost function.

20. The apparatus of claim 19, wherein the first portion of the time interval is a first half of the time interval, the second portion of the time interval is a second half of the time interval, and wherein the at least one processor and the memory are operable to update the one or more cancellation coefficients and measure the cost function occur in the same time interval.

21. The apparatus of claim 19, wherein the first portion of the time interval is a first half of the time interval, the second portion of the time interval is a second half of the time interval, wherein the at least one processor and the memory are further operable to additionally measure a response of the cost function of perturbing the one or more cancellation coefficients in the second half of the time interval, and wherein the at least one processor and the memory are operable to update the one or more cancellation coefficients based at least in part on additionally measuring the response of the cost function in the second half of the time interval.

22. The apparatus of claim 18, wherein the protocol time interval corresponds to a transmission cycle during which power used by the transmitter chain is substantially constant.

23. The apparatus of claim 18, wherein the protocol time interval corresponds to a transmission time interval (TTI).

24. The apparatus of claim 23, wherein the TTI is a subframe.

25. The apparatus of claim 24, wherein the first portion of the time interval is a first slot of the subframe, and the second portion of the time interval is a second slot of the subframe.

26. The apparatus of claim 18, wherein the at least one processor and the memory are further operable to detect an uplink transmission cycle associated with the aggressor signal, wherein the at least one processor and the memory are operable to update the one or more cancellation coefficients during at least a portion of the uplink transmission cycle.

27. An apparatus for interference cancellation, comprising:
means for receiving a received signal at a receiver chain, where the received signal is interfered by an aggressor signal transmitted using a transmitter chain;
means for updating, in a second portion of a time interval, one or more cancellation coefficients based on a measurement made in a first portion of the time interval, wherein the time interval is within a protocol time interval of a protocol used by the transmitter chain; and
means for performing, based on the one or more updated cancellation coefficients, interference cancellation to cancel interference of the aggressor signal from the received signal.

28. The apparatus of claim 27, further comprising means for measuring, in the first portion of the time interval where interference statistics of the aggressor signal are substantially stationary over the time interval, a cost function associated with the received signal based on perturbing the one or more cancellation coefficients used in the cost function.

29. A computer-readable storage medium comprising code executable by a computer for interference cancellation, the code comprising:
code for receiving a received signal at a receiver chain, where the received signal is interfered by an aggressor signal transmitted using a transmitter chain;
code for updating, in a second portion of a time interval, one or more cancellation coefficients based on a measurement made in a first portion of the time interval, wherein the time interval is within a protocol time interval of a protocol used by the transmitter chain; and
code for performing, based on the one or more updated cancellation coefficients, interference cancellation to cancel interference of the aggressor signal from the received signal.

30. The computer-readable storage medium of claim 29, further comprising code for measuring, in the first portion of the time interval where interference statistics of the aggressor signal are substantially stationary over the time interval, a cost function associated with the received signal based on perturbing the one or more cancellation coefficients used in the cost function.
